(19) United States
(12) Patent Application Publication
(10) Pub. No.: US 2008/0295616 A1
(43) Pub. Date: Dec. 4, 2008

(54) Multi-stage horizontal elutriator

(76) Inventors: Chane-Yu Lai, Shetou Township (TW); Wei-Ting Syu, Houlong Township (TW); Siou-Rong Li, Jhongli City (TW); Tai-Shan Yu, Taipei City (TW); Yu-Fang Ho, Taipei City (TW); Po-Chen Hung, Taipei City (TW); Jei-Pai Chang, Taipei City (TW); Tung-Sheng Shih, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/005,293

(22) Filed: Dec. 27, 2007

(30) Foreign Application Priority Data
Jun. 1, 2007 (TW) 096119836

(51) Int. Cl. G01N 1/22

(52) U.S. Cl. 73/863.22

(57) ABSTRACT

A multi-stage horizontal elutriator includes a flow inlet, a flow outlet, a hollow container that is disposed between said flow inlet and said flow outlet. This hollow container has a guide-in portion, a first parallel plates set, a second parallel plates set, and a guide-out portion. The first plates set is different to the second plates set. So, the aerosol's falling distance can be shortened significantly. The relative culturable ratio and the survival efficiency for bioaerosols are both high. The structure is simple with low cost.

### BACKGROUND OF THE INVENTION

1. Field of the Invention

The present invention relates to a multi-stage horizontal elutriator. It has several functions. The aerosol's falling distance can be shortened significantly. The relative culturable ratio and the survival efficiency for bioaerosols are both high. The structure is simple with low cost.

2. Description of the Prior Art

Taiwan has a moderate climate and humid environment. It is very good for the growth of microorganism. The biological aerosol will influence the human's respiratory system greatly. Especially, the aerosol smaller than 3 μm (aerodynamic diameter) is easy to deposit in the alveolar region. For example, most spores have a size between 1-50 μm. These spores of aerosols are very possible to penetrate and stay in human's lungs.

It is obvious that the spores will threaten the respiratory system of a human. Also, the aerodynamic diameter of bacteria is similar to the one of spores. In fact, bacteria usually aggregate with others together so that the actual aerodynamic diameter is more than 1 μm.

The conventional aerosol samplers utilize the principles of inertial impact (like impactor), filtration and gravitational settling. They can be described as follows.

[1] Inertial impacting type. This type of sampler utilizes different mediums such as solid (having a glass plate), semi-solid (having agar) and liquid ones. The conventional Andersen impactor is a sampler has a petri dish already installed. It can be classified into one-stage, two-stage and six-stage types. If this sampler is used in a high concentration environment of aerosols, it will collect too much to analyze. The AGI-4 (AGI means all glass impinger, or briefly referred as AGI) and AGI-30 contain liquid medium. If the impacting force is too large, the biological aerosol will die and will not be cultured. Hence, the accuracy of experimental result is poor.

[2] Filtration type. By utilizing the filtration principle, the medium is the filter. The filter usually can be selected from cellulose, glass fiber, Nuclepore membrane filter, gelatin filter paper, etc. The filter is fixed on a filter holder (cassette) for sampling. However, the major problem is the drying effect for such filter. A lot of spores or bacteria will die under the dry environment. Hence, it is not suitable for the collecting of biological aerosols (spores or bacteria) with low tolerance for dry environment.

[3] Gravitational settling type. It utilizes an exposed petri dish to collect aerosols gradually falling down due to gravity as a function of aerosol terminal settling velocity. Therefore, its maximum collecting amount for the aerosols in the air is limited. In addition, this type of sampler will be influenced by wind and other factors. The accuracy is poor. About the principle of gravitational settling type elutriator, referring to FIG. 1, the equation is

$${L}_{d} = \frac{Uh}{{V}_{ts}} ;$$

U: the average horizontal velocity;
h the height of elutriator;
Vₜₛ: the aerosol terminal settling velocity;
L_{d}: the distance from the entrance to the end of deposit point;
As shown in FIG. 2, it shows that the curves L_{d1} and L_{d2} represent two moving paths of two particles (having different aerodynamic diameters) gradually fall down respectively. However, the user still has to face many other difficulties or problems for collecting aerosols. Except the collecting efficiency, the user must consider the influences on the relative survival efficiency, the culturable ratio and so on during the collecting, transporting, reserving and analyzing processes.
   Thus, there is a great need to develop a new aerosol sampler to overcome the above-mentioned disadvantages and problems.

### SUMMARY OF THE INVENTION

The primary object of the present invention is to provide a multi-stage horizontal elutriator. In which, the aerosol's falling distance (horizontal distance) can be shortened significantly.

The next object of the present invention is to provide a multi-stage horizontal elutriator. The relative culturable ratio and the survival efficiency for bioaerosols are both high.

Another object of the present invention is to provide a multi-stage horizontal elutriator. The structure is simple with low cost.

### BRIEF DESCRIPTION OF THE DRAWINGS

FIG. 1 is a view illustrating a moving path (or the limited trajectory) of a micro particle in a conventional device.

FIG. 2 shows a conventional horizontal elutriator having two moving paths of two particles gradually fall down.

FIG. 3 is a perspective view of the present invention.

FIG. 4 is a cross-sectional view of the present invention.

FIG. 5 is a view showing the second preferred embodiment of the present invention.

FIG. 6 is a view showing the third preferred embodiment of the present invention.

FIG. 7 illustrates an application of the present invention.

FIG. 8 shows the experimental results of this invention and three conventional samplers for a first challenge biological aerosol.

FIG. 9 shows the experimental results of this invention and three conventional samplers for a second challenge biological aerosol.

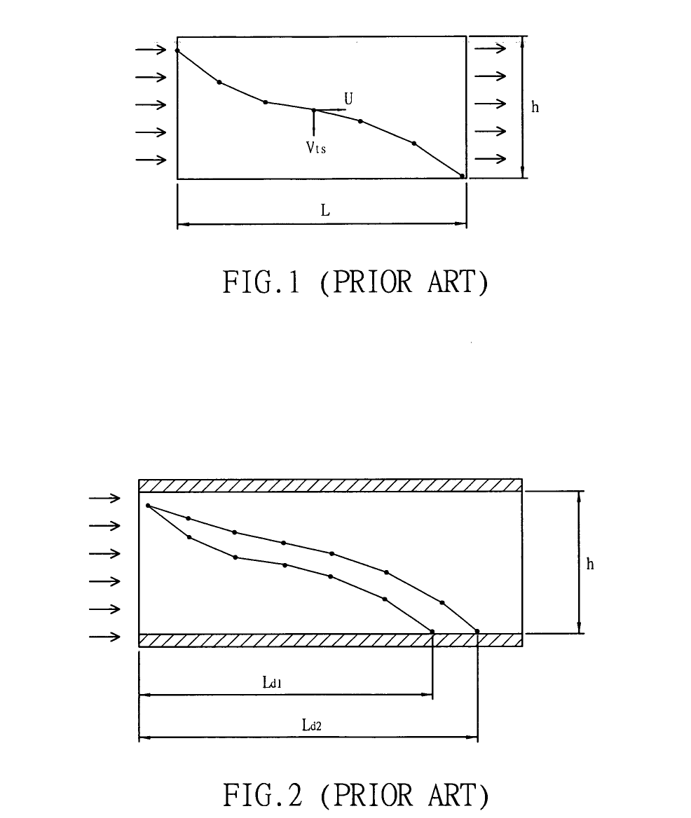

### DETAILED DESCRIPTION OF THE PREFERRED EMBODIMENT

The present invention relates to a multi-stage horizontal elutriator for collecting biological aerosols with the sized approximately between 1˜20 μm. The basic principle is to utilize the different settling speeds as a function of aerosol mass. The crucial point is that the aerosol in this invention gradually falls down and then stays on the plate rather than heavily hits on a plate or a liquid (in a conventional impinger). Such heavily impaction will make a viable bioaerosol die. However, the viable bioaerosol moves and falls down slowly in this invention. There is no heavy impact when it touches the plate. Hence, it significantly avoids a viable bioaerosol die. Besides, it is possible to collect viable bioaerosols with the size ranged approximately between 1˜20 μm.

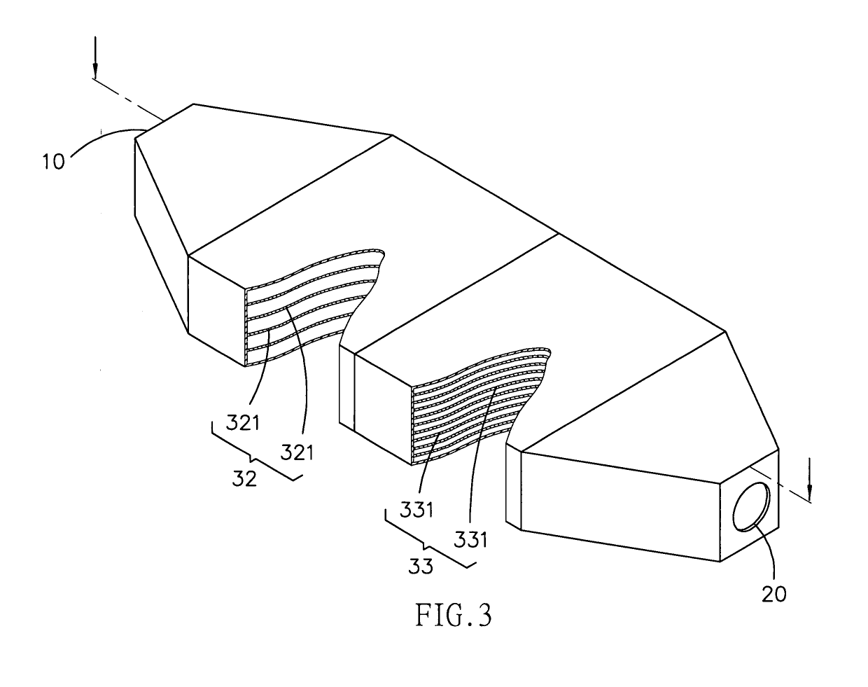

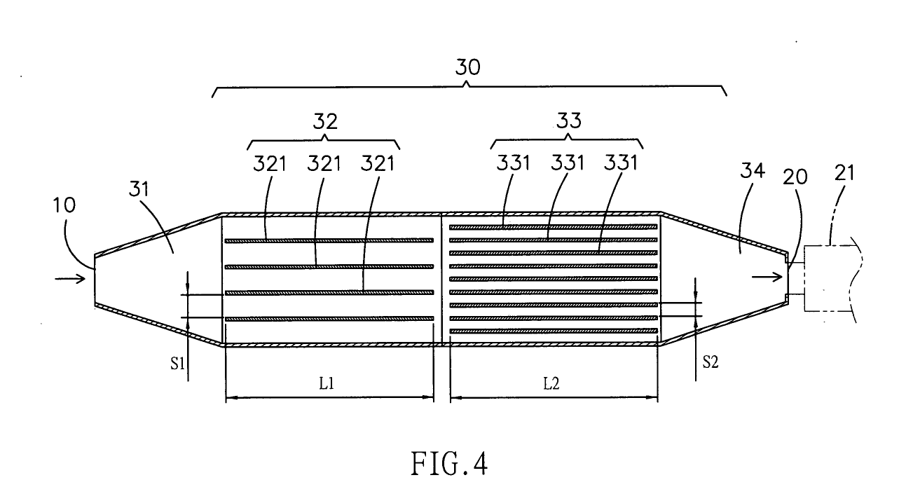

Referring to FIGS. 3 and 4, they show the first preferred embodiment of the present invention. It is used for collecting tiny particles or biological aerosols in a flowing gas or air.

The multi-stage horizontal elutriator comprising:
a flow inlet 10;
a flow outlet 20;
a hollow container 30 disposed between the flow inlet 10 and the outlet 20, the hollow container 30 including:
   [a] a guide-in portion 31 for guiding a flow in;
   [b] a first parallel plates set 32 including a number of first parallel plates 321, the number being defined as M (so as to form M-1 parallel channels), the neighboring first plates 321 being spaced by a first gap S1, each first plate 321 having a first length L1;
   [c] a second parallel plates set 33 including another number of second parallel plates 331, the another number being defined as N (so as to form another N-1 parallel channels), the neighboring second plates 331 being spaced by a second gap S2, each second plate 331 having a second length L2; and M being not equal to N, M≧3 and N≧3; and
   [d] a guide-out portion 34 for guiding the flow out.

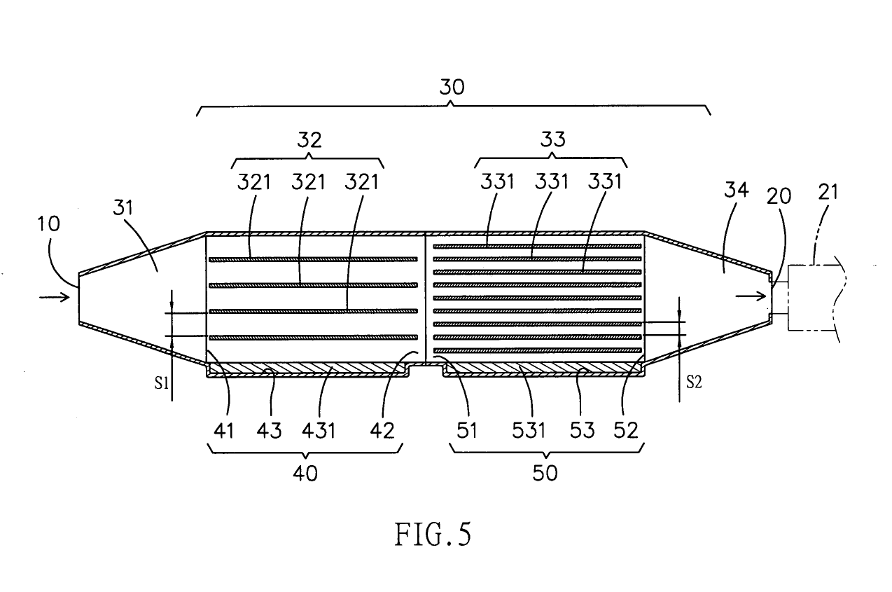

Of course, as shown in FIGS. 4 and 5, in order to increase the sampling flow rate, an air pump can be installed at the flow outlet 20 to draw the flow (or air) out compulsively.

As illustrated in FIG. 4, assume that the present invention is installed in a conventional experimental system 70 (as shown in FIG. 7). This invention can collect two ranges of aerosols, namely 1˜5 μm and 6˜20 μm. When a flow with certain amount of aerosols enters the flow inlet 10, these aerosols flow into the space of the hollow container 30. The larger aerosols of 6˜20 μm will gradually fall on these first parallel plates 321 of the first plates set 32. The smaller aerosols of 1˜5 μm will gradually fall on these second parallel plates 331 of the second plates set 32. By such design, aerosols having different sizes can be separated and collected in different portions. In the first plates set 32, the larger aerosols (6˜20 μm) can be found or calculated; whereas the smaller aerosols (1˜5 μm) can be found and calculated in the second plates set 33. It is easier to collect, count and analyze the aerosols with different sizes.

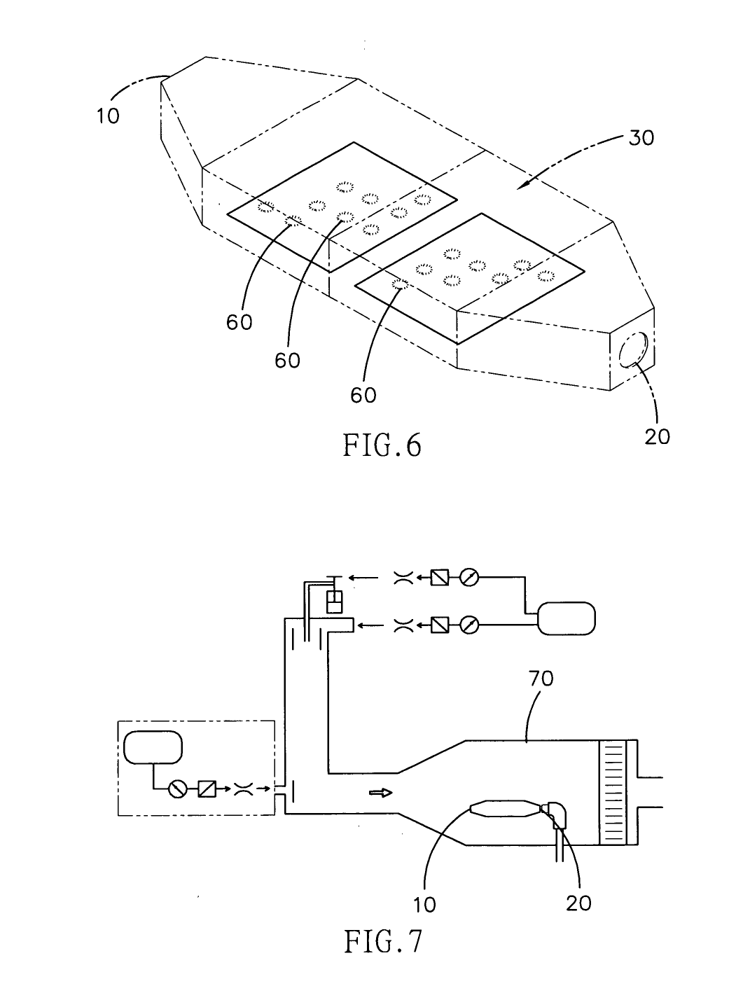

Furthermore, as shown in FIGS. 5 and 6, the second preferred embodiment of the present invention is used for collecting biological aerosols (especially for viable bioaerosols). Except the structure mentioned in the first preferred embodiment, it further comprises a first petri dish portion 40 and a second petri dish portion 50.

The first petri dish portion 40 is disposed beneath the first plates set 32. The first petri dish portion 40 has a first entrance 41, a first exit 42 and a first recess 43. A height of the first entrance 41 is approximately equal to the first gap S1. A height of the first exit 42 is approximately equal to the first gap S1, too. The first recess 43 contains a first growth medium layer 431, such as a nutrient broth, trypticase soy agar (or called TSA), malt extract agar (or called MEA) or the like.

The second petri dish portion 50 is disposed beneath the second plates set 33. The second petri dish portion 50 has a second entrance 51, a second exit 52 and a second recess 53. A height of the second entrance 51 is approximately equal to the second gap S2. A height of the second exit 52 is approximately equal to said second gap S2, too. The second recess 53 contains a second growth medium layer 531.

The use of the second preferred embodiment is similar to the one of the first preferred embodiment. If the user wants to observe or analyze the collected viable bioaerosols, the first growth medium layer (rectangular culture plate) 431 and the second growth medium layer (rectangular culture plate) 531 provide sufficient nutrition to let them forming colonies so that people can see them after direct culturing in an oven. When they grow up, there will be many colonies. Under such circumstance, people can enumerate the bioaerosol concentration directly or examine them by using a microscope. Referring to FIG. 6, there are several colony forming units 60 large enough that can be seen after direct culturing in an oven (the rectangular petri dishes should be move out from the multi-stage elutriator). Therefore, it is very easy for a user to count the total number of colony forming units 60 for estimating the concentration of collected biological aerosols. It is extremely convenient.

Moreover, no matter for the first preferred embodiment (without any petri dish portion) or the second preferred embodiment (with petri dish portions), they utilize the same equation for the horizontal elutriator. That is the equation (1) shown below. According to the Equation (1), all parameters and their relationships can be seen. Hence, a desired particle or aerosol size to be collected can be calculated.

$${L}_{d} = \frac{{U}_{2} \times {h}_{2}}{{V}_{ts}} = \frac{( {U}_{1} \times \frac{{A}_{1}}{{A}_{2}} ) \times {h}_{2}}{{V}_{ts}} \qquad ( 1 )$$

wherein

L_{d}: falling distance (horizontal distance);

U₁: inlet flow velocity;

U₂: flow velocity entering the plates;

A₁: inlet cross-sectional area;

A₂: cross-sectional area before entering the plates;

h₂: gap between two neighboring plates.

As shown in Table 1, assuming the density of the biological aerosol is 1, the estimated falling distance (horizontal distance) for different sized aerosols of 1 [symbol] 2 [symbol] 5 [symbol] 10 [symbol] 20 and 50 μm on a horizontal plate can be calculated respectively. Also, different numbers of parallel plates will influence the corresponding falling distance (horizontal distance). Therefore, the user can design a horizontal elutriator for capturing the aerosols having a predetermined size range. Also, the L means the number of the channels in the horizontal elutriator.

TABLE 1

| Aerosol | Aerosol | | 2 L-L_{d} | | |
|---|---|---|---|---|---|
| aerodynamic | terminal | 1 L-L_{d} | (1 | 5 L-L_{d} | 10 L-L_{d} |
| diameter | settling | (0 separating | separating | (4 separating | (9 separating |
| (μm) | velocity (Vts) | plate) | plates) | plates) | plates) |
| 1 | 0.003511 | 951.2959 | 475.648 | 190.2592 | 95.12959 |
| 2 | 0.01304 | 256.135 | 128.0675 | 51.22699 | 25.6135 |
| 5 | 0.07777 | 42.94715 | 21.47358 | 8.58943 | 4.294715 |
| 10 | 0.3061 | 10.91147 | 5.455733 | 2.182293 | 1.091147 |
| 20 | 1.214 | 2.751236 | 1.375618 | 0.550247 | 0.275124 |
| 50 | 7.553 | 0.442208 | 0.221104 | 0.088442 | 0.044221 |

Based on the calculation results in Table 1, if someone wants to use a zero-separating-pate horizontal elutriator for capturing the biological aerosol of 5 μm at a fixed sampling flow rate of 2 L/min as well as the inlet width of 1 cm and height 0.2 cm, and the internal cross-sectional area of 10×2 cm², then the required falling distance is approximately 42.9 cm. Similarly, if this person wants to capture the biological aerosols of 2 μm, the corresponding falling distance becomes 256.1 cm.

Such 256.1 cm distance is too long. It is not suitable to manufacture such huge horizontal elutriator. Hence, it is wise to add more separating plates. By doing so, if someone wants to collect the aerosols of 5 μm by utilizing the 5-channel-type (having four separating plates), the required falling distance is significantly shortened into 8.6 cm. With regard to the aerosols of 2 μm by utilizing the 10-channel-type (having nine separating plates), the required falling distance is sharply reduced into 25.6 cm. That means it is feasible for commercial applications.

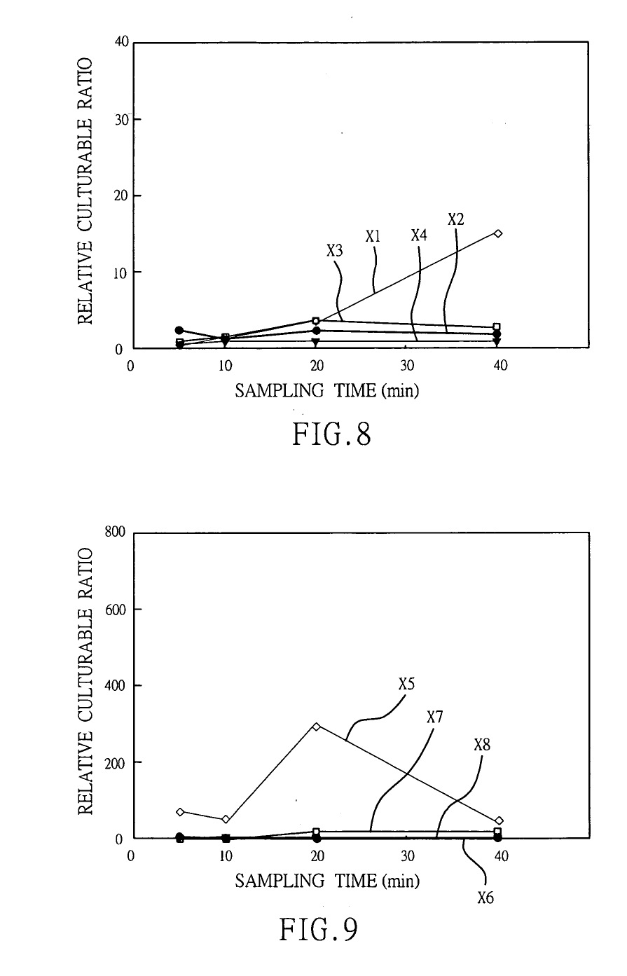

Referring to FIG. 8, it shows the experiment result about relative culturable ratio. There are four curves in FIG. 8.

[a] The first curve X1 means the result of this invention or call the New biosampler.

[b] The second curve X2 represents the result of the first conventional sampler that is the aerosol sampler of Andersen 1-stage type.

[c] The third curve X3 is the result of the second conventional sampler that is the all-glass-impinger 30 (Model No. AGI-30) sampler.

[d] The fourth curve X4 mans the result of the third conventional sampler that is the new all-glass-impinger (new AGI) bioaerosol sampler.

In this experiment, the biological aerosols to be collected is the Gram-positive Bacilus subtilis (or briefly called B. subtilis). While comparing this invention with other three conventional samplers, relative culturable ratio is based on the culturable ratio of the third conventional bioaerosol sampler (new AGI). Also, the sampling time is based on 5, 10, 20 and 40 minutes. As the sampling time increases, the relative culturable ratio of the present invention is getting higher. After the 20 minutes, it is obvious that this invention is significantly better than others. Especially at the time of 40 minutes, the relative culturable ratio of the present invention (the first curve X1) increases to approximately 15. It is much higher than the other three conventional samplers (see the second curve X2, the third curve X3, and the fourth curve X4). Therefore, the sampling result of this invention is excellent.

As shown in FIG. 9, the biological aerosols to be collected are changed to the Gram-negative Escherichia coli (or briefly called E. coli). But, the results are based on the data (which is the sixth curve X6) of the first conventional sampler (that is the Andersen 1-stage type). According to FIG. 10, the result the present invention (which is the fifth curve X5) is better than other three samplers. At the time of 20 minutes, it is obvious that this invention (which is the fifth curve X5) surges to roughly 300 (if comparing with the sixth curve X6). Meanwhile, this invention is significantly better than the second and the third conventional samplers (see the seventh curve X7 and the eighth curve X8 respectively). By the way, please note the sixth curve X6 and the eighth curve X8 are very close (almost overlapped).

So, the design of this invention is to combine a five-channels horizontal elutriator and a ten-channels horizontal elutriator together. That is, the front stage (having 5 channels) and the rear stage (having 10 channels), this invention becomes a multi-stage horizontal elutriator. Finally, the non-collected aerosols can be collected by a post filter (or called after filter). Of course, the top one and bottom one of the first or second parallel plates 321,331 may be modified as the inner walls of the hollow container 30.

The advantages and functions of the present invention can be summarized as follows.

[1] The aerosol's falling distance (horizontal distance) can be shortened significantly. This invention has two or more sets of parallel plates inside the space of the hollow container for collecting aerosols with a specific size range. Hence, the aerosol's falling distance can be shortened significantly. The conventional single-stage one needs the falling distance of 256.1 cm for aerosols of 2 μm; whereas the present invention's multi-stage design only needs the falling distance of 25.6 cm. Thus, the volume of the horizontal elutriator can be minimized.

[2] The relative culturable ratio and the survival efficiency for bioaerosols are both high. In this invention, the aerosols gradually fall down at a relative slower moving speed. So, when aerosols contact the plate, their hitting forces are quite small. Therefore, the relative culturable ratio and the survival efficiency for bioaerosols are both high.

[3] The structure is simple with low cost. After a simple calculation, the parallel plates set can be determined and designed. If the additional petri dish portions are added, then it can collect the biological aerosols (especially the live ones, not the dead ones). Thus, the overall structure is very simple. Plus, the cost is low.

The above embodiments are only used to illustrate the present invention, not intended to limit the scope thereof. Many modifications of the above embodiments can be made without departing from the spirit of the present invention.

What is claimed is:

1. A multi-stage horizontal elutriator comprising:
a flow inlet;
a flow outlet;
a hollow container disposed between said flow inlet and said flow outlet, said hollow container including:
[a] a guide-in portion for guiding a flow in;
[b] a first parallel plates set including a number of first parallel plates, said number being defined as M, said neighboring first plates being spaced by a first gap, each first plate having a first length;
[c] a second parallel plates set including another number of second parallel plates, said another number being defined as N, said neighboring second plates being spaced by a second gap, each second plate having a second length; and M being not equal to N, M≧3 and N≧3; and
[d] a guide-out portion for guiding said flow out.

2. The multi-stage horizontal elutriator as claimed in claim 1, wherein
a first petri dish portion is disposed beneath said first plates set, said first petri dish portion having a first entrance, a first exit and a first recess; a height of said entrance being approximately equal to said first gap, and a height of said first exit being approximately equal to said first gap; said first recess containing a first growth medium layer; and
a second petri dish portion is disposed beneath said second plates set, said second petri dish portion having a second entrance, a second exit and a second recess; a height of said second entrance being approximately equal to said second gap, and a height of said second exit being approximately equal to said second gap; said second recess containing a second growth medium layer.
